(19) United States
(12) Patent Application Publication
(10) Pub. No.: US 2024/0039473 A1
(43) Pub. Date: Feb. 1, 2024

(54) SYSTEM AND METHOD FOR DETERMINING THE OPERATING STATE OF SOLAR PHOTOVOLTAIC MODULES

(71) Applicant: UNIVERSIDAD TÉCNICA FEDERICO SANTA MARÍA, Valparaíso (CL)

(72) Inventors: Rodrigo Alejandro CORTÉS SEVERINO, Santiago (CL); Carlos Rodrigo CÁRDENAS BRAVO, Santiago (CL); Patricio VALDIVIA LEFORT, Santiago (CL); Antonio Alejandro SÁNCHEZ SQUELLA, Santiago (CL); Rodrigo Sebastián BARRAZA VICENCIO, Santiago (CL)

(21) Appl. No.: 18/269,102

(22) PCT Filed: Dec. 22, 2020
(86) PCT No.: PCT/CL2020/050191

§ 371 Date: Jun. 22, 2023

(51) Int. Cl. H02S 50/10

(52) U.S. Cl. CPC H02S 50/10

(57) ABSTRACT

The present invention relates to the monitoring of photovoltaic systems, and in particular provides a system for determining the operating state of a solar photovoltaic module that include means for acquiring a voltage signal, operatively connected to a voltage output of said solar photovoltaic module; and a processor operatively connected to said means for acquiring said output voltage signal which, by using Fourier transforms and reference spectra, determines the operating state of the solar photovoltaic module. The present invention further provides a method for determining the operating state of solar photovoltaic modules.

### TECHNICAL FIELD OF INVENTION

The present invention relates to the field of electric power generation and distribution, more specifically to the monitoring of photovoltaic systems and, in particular, provides a system and a method for determining the operating state of solar photovoltaic modules.

### BACKGROUND OF THE INVENTION

Different health status detection methods have been developed for solar photovoltaic modules (SPVM), among which are the operation characterization in the voltage/current plane, electroluminescence, visual inspection, among others.

These methods mostly require the disconnection of the SPVM or a group of them to determine the health status, which is disadvantageous as it interrupts the continuity of service of the group of modules under test. Moreover, in general, they are not able to identify the nature of the failure in case of detecting any anomaly.

For example, patent document EP 3537602 describes a method of photovoltaic panels diagnostic. The photovoltaic system used as a reference includes a photovoltaic panel and an inverter connected to the photovoltaic panel. The method comprises, as a first step, acquiring a voltage signal on the DC side of the inverter. It mentions that it obtains a fast Fourier transform of the voltage signal in order to obtain a system operation “fingerprint”. Although the signals obtained are compared with each other to obtain system indicator values, it is not mentioned that they allow determining a nature of the fault.

On the other hand, US 2016/282398 describes a monitoring method and system for arc fault detection in a photovoltaic system. It is described that the system allows the monitoring of the inverter. For this, it obtains current signals on the DC side of the inverter. It is mentioned that one way to detect a fault is by means of a power threshold in the frequency spectrum where, if the minimum of the frequency spectrum is above said threshold, it will be indicative of a fault. However, it is not mentioned that it could allow identifying the nature of the fault. On the other hand, although a voltage signal is acquired on the DC side, the same is obtained when the inverter is disconnected.

Consequently, a system and a method for determining the operating state of an SPVM that does not require the interruption in operation and that allows identifying the nature of the fault is required.

### SUMMARY OF THE INVENTION

The present invention provides a system for determining the operating state of a solar photovoltaic module, characterized in that it comprises: means for acquiring a voltage signal, operatively connected to a voltage output of said solar photovoltaic module; and a processor operatively connected to said means for acquiring said output voltage signal; wherein said processor is configured to: acquire, by said means for acquiring a voltage signal, an output voltage of said solar photovoltaic module; obtain a Fourier transform of said voltage signal; compare said Fourier transform with a reference spectrum; and determine the operating state of said solar photovoltaic module from said comparison; and wherein said acquisition of said output voltage signal is performed with the solar photovoltaic module in operation and connected to a power conversion system.

In a preferred embodiment, the system is characterized in that said means for acquiring a voltage signal comprise a DC-DC converter including a switch, and in that said voltage signal is measured between the terminals of said switch.

In another preferred embodiment, the system is characterized in that said reference spectrum is selected from the group consisting of spectra corresponding to soiling, spectra corresponding to cracks, spectra corresponding to hot spots, spectra corresponding to delamination, spectra corresponding to snail tracks, spectra corresponding to normal operation, as well as combinations thereof.

In a further preferred embodiment, the system is characterized in that said comparison comprises obtaining, from said Fourier transform and from said reference spectrum, a parameter which is selected from the group formed by cutoff frequency and a damping coefficient, as well as a combination thereof; and in that said determination of the operating state comprises determining that said Fourier transform corresponds to said reference spectrum if the difference between the parameter obtained for the Fourier transform and for the reference spectrum is less than a threshold value. In a more preferred embodiment, the system is characterized in that said threshold value is in the range between +/−0.1% and +/−1.0%.

In a preferred embodiment, the system is characterized in that said comparison comprises obtaining a correlation coefficient between said Fourier transform and said reference spectrum; and in that said determination of the operating state comprises determining that said Fourier transform corresponds to said reference spectrum if said correlation coefficient is greater than a threshold value. In a more preferred embodiment, the system is characterized in that said threshold value is in the range between 0.99 and 0.999.

In another preferred embodiment, the system is characterized in that said comparison comprises obtaining a root mean square error between said Fourier transform and said reference spectrum; and in that said determination of the operating state comprises determining that said Fourier transform corresponds to said reference spectrum if said root mean square error is less than a threshold value. In a more preferred embodiment, the system is characterized in that said threshold value is in the range between 0.005 and 0.05.

In another subject matter of the present invention, a method for determining the operating state of a solar photovoltaic module is provided, characterized in that it comprises: acquiring, by means of means for acquiring a voltage signal, operatively connected to a voltage output of said solar photovoltaic module, an output voltage signal of said solar photovoltaic module; obtaining, by means of a processor operatively connected to said means for acquiring said output voltage signal, a Fourier transform of said voltage signal; comparing, by means of said processor, said Fourier transform with a reference spectrum; and determining, by means of said processor, the operating state of said solar photovoltaic module from said comparison; and wherein said acquisition of said output voltage signal is performed with the solar photovoltaic module in operation and connected to a power conversion system.

In a preferred embodiment, the method is characterized in that said reference spectrum is selected from the group consisting of spectra corresponding to soiling, spectra corresponding to cracks, spectra corresponding to hot spots, spectra corresponding to delamination, spectra corresponding to snail tracks, spectra corresponding to normal operation, as well as combinations thereof.

In another preferred embodiment, the method is characterized in that said step of comparing said Fourier transform with said reference spectrum comprises obtaining, from said Fourier transform and from said reference spectrum, a parameter which is selected from the group consisting of cutoff frequency and a damping coefficient, as well as a combination thereof; and in that said step of determining the operating state of the solar photovoltaic module comprises determining that said Fourier transform corresponds to said reference spectrum if the difference between the parameter obtained for the Fourier transform and for the reference spectrum is less than a threshold value. In a more preferred embodiment, the method is characterized in that said threshold value is in the range between +/−0.1% and +/−1.0%.

In a further preferred embodiment, the method is characterized in that said step of comparing said Fourier transform with said reference spectrum comprises obtaining a correlation coefficient between said Fourier transform and said reference spectrum; and in that said step of determining the operating state of said solar photovoltaic module comprises determining that said Fourier transform corresponds to said reference spectrum if said correlation coefficient is greater than a threshold value. In a more preferred embodiment, the method is characterized in that said threshold value is in the range between 0.99 and 0.999.

In another preferred embodiment, the method is characterized in that said step of comparing said Fourier transform with said reference spectrum comprises obtaining a root mean square error between said Fourier transform and said reference spectrum; and in that said step of determining the operating state of said solar photovoltaic module comprises determining that said Fourier transform corresponds to said reference spectrum if said root mean square error is less than a threshold value. In a more preferred embodiment, the method is characterized in that said threshold value is in the range between 0.005 and 0.05.

### BRIEF DESCRIPTION OF THE FIGURES

FIG. 1 illustrates a block diagram of a first embodiment of the system which is the subject matter of the present invention.

FIG. 2A illustrates an exemplary embodiment of a voltage signal and a reference signal in the time domain.

FIG. 2B illustrates an exemplary embodiment of a Fourier transform of the voltage signal of FIG. 2A and a reference spectrum.

FIG. 3A illustrates an exemplary embodiment of three reference signals in the time domain.

FIG. 3B illustrates an exemplary embodiment of three reference spectra obtained from the reference signals of FIG. 3A.

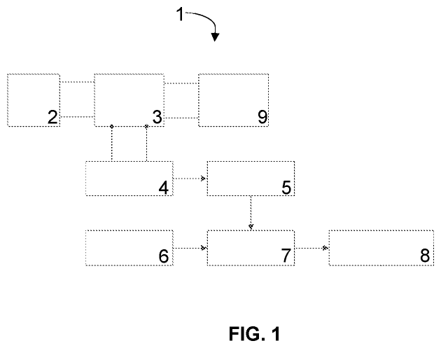

### DETAILED DESCRIPTION OF THE INVENTION

The present invention will be described in detail below, referring for this purpose to the figures accompanying the present application.

In a first subject matter of the present invention, a system (1) for determining the operating state of a solar photovoltaic module (2) is provided, comprising, essentially, means (3) for acquiring a voltage signal operatively connected to a voltage output of said solar photovoltaic module (2); and a processor (4) operatively connected to said means (3) for acquiring said output voltage signal. Further, said processor (4) is configured to: acquire, by means of said means for acquiring a voltage signal, an output voltage of said solar photovoltaic module; obtain a Fourier transform (5) of said voltage signal; compare (7) said Fourier transform (5) with a reference spectrum (6); and determine (8) the operating state of the solar photovoltaic module (2) from said comparison. Additionally, said acquisition of said output voltage signal is performed with the solar photovoltaic module (2) in operation and connected to a power conversion system (9).

In the context of the present invention, without limiting the scope of the same, the means (3) for acquiring a voltage signal should be understood as one or more elements which, as a whole, allow acquiring a voltage signal from the solar photovoltaic module (2), without requiring the disconnection of said solar photovoltaic module from a power conversion system (9). For example, and without limiting the scope of the present invention, said means (3) for acquiring a voltage signal may comprise, without limiting the scope of the present invention, voltmeters; switches; passive elements such as coils, resistors, capacitors, diodes; active elements, such as bipolar transistors, field effect transistors; as well as a combination thereof. Additionally, without limiting the scope of the present invention, said means (3) for acquiring a voltage signal may comprise one or more analog-to-digital converters.

In an exemplary embodiment, without limiting the scope of the present invention, said means (3) for acquiring a voltage signal comprise a DC-DC converter including a switch, and wherein said voltage signal is measured between the terminals of said switch. In a more preferred embodiment, without limiting the scope of the present invention, said DC-DC converter is a DC-DC converter without galvanic isolation.

Said means (3) for acquiring a voltage signal may acquire said output voltage signal from the solar photovoltaic module (2) in a substantially continuous manner, at regular intervals, or at irregular intervals without limiting the scope of the present invention. In the context of the present invention, it should be understood that said acquisition is performed in a substantially continuous manner when the time difference between the acquisition of two consecutive signals is less than a certain threshold value. For example, and without limiting the scope of the present invention, said threshold value may be less than 0.5 milliseconds, more preferably less than 0.1 milliseconds, and even more preferably less than 0.05 milliseconds.

The system (1) which is the subject of the present invention further comprises a processor (4) operatively connected to said means (3) for acquiring a voltage signal. In the context of the present invention, without limiting the scope of the same, it should be understood that said processor (4) is operatively connected to said means (3) for acquiring a voltage signal when said processor (4) can control the operation of said means (3) for acquiring a voltage signal and receive said voltage signal from said means (3) for acquiring a voltage signal. The means by which said processor (4) operatively connects with said means (3) for acquiring a voltage signal may be wired, wireless, or a combination of both without limiting the scope of the present invention. For example, and without limiting the scope of the present invention, said means may comprise UTP cables, STP cables, coaxial cables, telephone pair cables, optical fiber, USB cables, Bluetooth antennas, Wi-Fi antennas, LEDs, Lasers, photodiodes, as well as a combination thereof.

Said processor (4) is furthermore configured to acquire, by means of said means (3) for acquiring a voltage signal, an output voltage of said solar photovoltaic module (2). As previously mentioned, said acquisition may be performed in a substantially continuous manner, at regular intervals, or at irregular intervals without limiting the scope of the present invention. Additionally, the range of time during which said voltage signal is acquired does not limit the scope of the present invention. For example, and without limiting the scope of the present invention, said acquisition may be performed during a time that is in the range between 0.05 milliseconds and 500 milliseconds, more preferably between 0.1 milliseconds and 50 milliseconds, and even more preferably between 0.15 milliseconds and 1 millisecond. Said acquisition, in turn, should allow measuring the transient response of the solar photovoltaic module (2) to power conversion system switching (9) or, if present, switching incorporated by the means (3) for acquiring the voltage signal. For example, and without limiting the scope of the present invention, said acquisition of said voltage signal may or may not be performed after each power conversion system switching (9) without limiting the scope of the present invention.

After acquiring said voltage signal, said processor (4) is configured to obtain a Fourier transform (5) of said voltage signal. For example, and without limiting the scope of the present invention, said processor (4) may be configured to obtain a fast Fourier transform (FFT) of said voltage signal, a discrete Fourier transform (DFT), as well as a combination thereof. The frequency range, as well as the frequency step, in which said processor obtains said Fourier transform, does not limit the scope of the present invention and will depend, for example and without limiting the scope of the present invention, on the time range in which the voltage signal is acquired and on the acquisition rate of the voltage signal. In a preferred embodiment, without limiting the scope of the present invention, said frequency range may be between 0 kHz and 1 MHz, more preferably between 0 kHz and 500 kHz, and even more preferably between 0 kHz and 300 kHz. In another preferred embodiment, without limiting the scope of the present invention, the sampling frequency of the voltage signal may be in the range of between 1 kHz and 50 kHz, more preferably between 100 kHz and 1 MHz, and even more preferably between 50 MHz and 500 MHz.

Furthermore, said processor (4) is configured to compare (7) said Fourier transform (5) with a reference spectrum (6). Said comparison with said reference spectrum (6) is the one which, advantageously, allows identifying the nature of the fault in case the solar photovoltaic module (2) is not operating normally. Said reference spectrum (6) may, for example and without limiting the scope of the present invention, be stored in a memory operatively connected to the processor (4) or be acquired from a standard solar photovoltaic module (not illustrated in the Figures), wherein said standard solar photovoltaic module shows a known fault. In the latter preferred embodiment, for example and without limiting the scope of the present invention, said processor (4) may be configured to acquire a standard output voltage signal from said standard solar photovoltaic module, by suitable means, and to obtain said reference spectrum by means of a Fourier transform of said standard output voltage signal.

In a preferred embodiment, without limiting the scope of the present invention, said processor (4) may be configured to compare said Fourier transform (5) with a plurality of reference spectra (6). In the context of the present invention, a plurality should be understood as two or more of the elements to which reference is made. Said plurality of reference spectra may or may not correspond to the same type of malfunction of the solar photovoltaic module (2) without limiting the scope of the present invention. In a preferred embodiment, without limiting the scope of the present invention, said plurality of reference spectra (6) corresponds to different types of failure of the solar photovoltaic module (2).

Although an embodiment of the system (1) which is the subject of the present invention, in which the processor (4) is configured to compare the Fourier transform (5) with a single reference spectrum (6), will be described hereunder, a person ordinarily skilled in the art will understand that all the described options are applicable for cases in which said processor (4) is configured to compare said Fourier transform (5) with a plurality of reference spectra (5).

Said reference spectrum (6) may be chosen from spectra corresponding to any type of failure in the solar photovoltaic module (2), without limiting the scope of the present invention. Additionally, and without limiting the scope of the present invention, said reference spectrum (6) may correspond to a normal operation of the solar photovoltaic module (2). For example, and without limiting the scope of the present invention, said reference spectrum may be selected from the group formed by spectra corresponding to soiling, spectra corresponding to cracks, spectra corresponding to hot spots, spectra corresponding to delamination, spectra corresponding to snail tracks, spectra corresponding to normal operation, as well as combinations thereof.

In the context of the present invention, comparison (7) should be understood as the application of one or more mathematical operations to said Fourier transform (5) and to said reference spectrum (6), in such a way as to allow determining a correspondence between both.

For example, and without limiting the scope of the present invention, said comparison (7) may comprise obtaining, from said Fourier transform (5) and from said reference spectrum (6), a parameter which is selected from the group formed by a cutoff frequency, a damping coefficient, as well as a combination thereof. In this case, it will be understood that said Fourier transform (5) corresponds to said reference spectrum (6) if the difference between the parameter obtained for the Fourier transform and for the reference spectrum is less than a threshold value.

In the context of the present invention, without limiting the scope of the same, the cutoff frequency should be understood as the frequency for which the signal shows an energy lower than a certain limit (usually defined in 3 dB), both in the Fourier transform (5) and in the reference spectrum (6). On the other hand, in the context of the present invention, without limiting the scope of the same, the damping coefficient should be understood as a measure of the magnitude and quantity of harmonics present both in the Fourier transform (5) and in the reference spectrum (6).

Said threshold value may be any value suitable for determining said correspondence between said Fourier transform (5) and said reference spectrum (6). For example, and without limiting the scope of the present invention, said threshold value may be in the range between +/−0.05% and +/−1.0%, more preferably between +/−0.1% and +/−0.8%, and even more preferably be +/−0.5%.

In another exemplary embodiment, without limiting the scope of the present invention, said comparison (7) may comprise obtaining a correlation coefficient between said Fourier transform (5) and said reference spectrum (6). In this case, that said Fourier transform (5) will correspond to said reference spectrum (6) if said correlation coefficient is greater than a threshold value.

In the context of the present invention, without limiting the scope of the same, the correlation coefficient should be understood as a measure of the linear dependence between the Fourier transform (5) and the reference spectrum (6). In view of the above, the higher the level of correlation of the signals, the closer the correlation coefficient will be to 1.

Said threshold value may be any value suitable for determining said correspondence between said Fourier transform (5) and said reference spectrum (6). For example, and without limiting the scope of the present invention, said threshold value may be in the range between 0.95 and 1, more preferably between 0.98 and 0.999, and even more preferably be 0.995.

In another example, without limiting the scope of the present invention, said comparison (7) may comprise obtaining a root mean square error (RMSE) of the difference between said Fourier transform (5) and said reference spectrum (6). In this case, said Fourier transform (5) will correspond to said reference spectrum (6) if said root mean square error (RMSE) is less than a threshold value.

In the context of the present invention, without limiting the scope of the same, the root mean square error (RMSE) should be understood as a measure of the deviation between the frequencies indicated by the Fourier transform (5) and the reference spectrum (6).

Said threshold value may be any value suitable for determining said correspondence between said Fourier transform (5) and said reference spectrum (6). For example, and without limiting the scope of the present invention, said threshold value may be in the range between 0.001 Hz and 0.07 Hz, more preferably between 0.005 Hz and 0.05 Hz, and even more preferably be 0.01 Hz.

As previously mentioned, said processor (4) is configured to determine (8) the operating state of the solar photovoltaic module (2). For this, said processor (4) uses the result of the comparison between the Fourier transform (5) and the reference spectrum (6). In this way, the processor (4) can not only determine whether said solar photovoltaic module (2) is operating normally or defectively but, additionally and advantageously, can determine the nature of the fault in case of a malfunction.

Additionally, as previously mentioned, the system (1) which is the subject matter of the present invention has the advantage that it does not require the disconnection of the solar photovoltaic module (2) from the power converter system (9) in order to determine the operating state.

The system (1) which is the subject matter of the present invention may comprise, optionally and without limiting the scope of the present invention, additional elements to those previously described. For example, and without limiting the scope of the present invention, the system (1) may comprise a radio frequency transceiver operatively connected to said processor (1) and said processor may be configured to execute one or more of the following tasks:
receiving an instruction to determine the operating state of the solar photovoltaic module (2) by means of said radio frequency transceiver;
transmitting the operating state of the solar photovoltaic module (2) by means of said radio frequency transceiver;
generating an alarm in response to determining that the solar photovoltaic module (2) is malfunctioning and transmitting said alarm by means of said radio frequency transceiver.

In said preferred embodiment, the nature of the radio frequency transceiver does not limit the scope of the present invention, and may be selected from the group consisting of Bluetooth antennas, Wi-Fi antennas, as well as a combination of both.

In another optional embodiment, without limiting the scope of the present invention, said system (1) may comprise a memory operatively connected to said processor (4). Said memory may be a volatile or non-volatile memory, as well as a combination of both, without limiting the scope of the present invention. As previously mentioned, said memory may store one or more reference spectra (6) that allow the comparison (7) between the Fourier transform (5) and each of said one or more reference spectra (6). In this preferred embodiment, additionally and without limiting the scope of the present invention, said processor (4) may be configured to execute one or more of the following tasks:
reading, from said memory, one or more reference spectra (6);
storing, in said memory, the output voltage signal that is acquired from the solar photovoltaic module (2);
storing, in said memory, the Fourier transform (5) obtained from the output voltage signal;
storing, in said memory, one or more records of the operating state of the solar photovoltaic module (2).

The present invention additionally provides a method for determining the operating state of a solar photovoltaic module (2) comprising, essentially, the steps of:
acquiring, by means of means for acquiring a voltage signal operatively connected to a voltage output of said solar photovoltaic module, an output voltage signal of said solar photovoltaic module;
obtaining, by means of a processor operatively connected to said means for acquiring said output voltage signal, a Fourier transform of said voltage signal;
comparing, by means of said processor, said Fourier transform with a reference spectrum; and
determining, by said processor, the operating state of said solar photovoltaic module from said comparison.

Additionally, said acquisition of said output voltage signal is performed with said solar photovoltaic module in operation and connected to a power conversion system.

All the options previously described for the system (1) are applicable for the method that is the subject of the present invention, without limiting the scope of the same.

According to the previously detailed description, it is possible to obtain a system (1) and a method for determining the operating state of a solar photovoltaic module (2). It should be understood that the various options described can be combined with each other, or with other options known to a person ordinarily skilled in the art, in any manner envisaged, without limiting the scope of the present invention.

Examples of embodiments of the system and method which are the subject matter of the present invention will be presented below. It should be understood that the purpose of these examples is to provide a better understanding of the present invention but in no way limit the scope of protection claimed. Additionally, technical features or parameters described in different examples may be combined with each other, or with any of the previously described embodiments, in any manner envisioned by a person ordinarily skilled in the art without limiting the scope of the present invention.

### Example 1: Acquisition of a Voltage Signal and a Time Domain Reference Signal

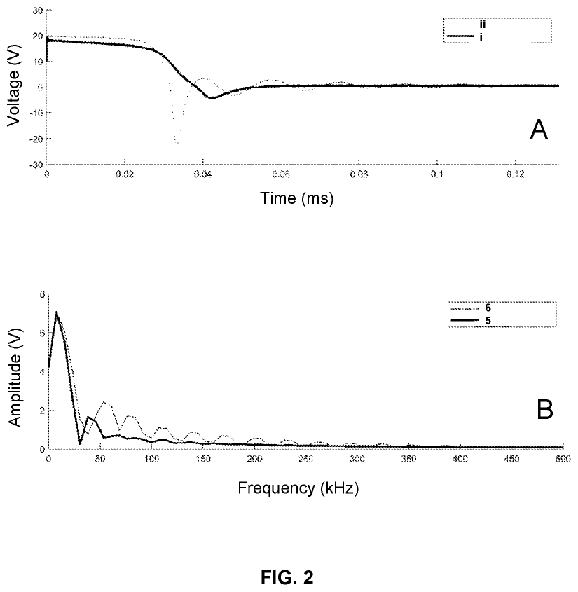

FIG. 2A illustrates a voltage signal (i) and a time domain reference signal (ii) corresponding to a solar photovoltaic module (2). In this exemplary embodiment, a fast Fourier transform of both signals was obtained, obtaining, respectively, a Fourier transform (5) and a reference spectrum (6), which are illustrated in FIG. 2B.

Said signals were acquired upon operation of a 10 Wp solar module connected to a DC/DC converter with an irradiance of 1000 W/m².

### Example 2: Obtaining Parameters from the Fourier Transform and the Reference Spectrum

From the Fourier transform (5) and the reference spectrum of the previous example, the following parameters were obtained to compare both signals: Cutoff Frequency, Damping Coefficient, Correlation Coefficient, and Root Mean Square Error.

The results are summarized in Table 1:

TABLE 1
Parameters obtained from Fourier transform
(5) and reference spectrum (6).

| | Reference | Fourier | |
|---|---|---|---|
| Parameter | Spectrum (6) | transform (5) | Difference (%) |
| Cutoff Frequency (kHz) | 15.905 | 13.204 | 16.98 |
| Damping coefficient (ms) | 0.0287 | 0.0271 | 5.57 |

| | | |
|---|---|---|
| Correlation coefficient | 0.9510 | — |
| RMSE (Hz) | 0.028 | — |

### Example 3: Comparison Between the Fourier Transform and the Reference Spectrum

The results of the previous example were used to make a comparison between the Fourier transform (5) and the reference spectrum (6). Previously, the following threshold values had been defined: for the cutoff frequency and for the damping coefficient, a difference of less than +/−0.5%; for the correlation coefficient a value greater than 0.995; and for the mean square error a value less than 0.01 Hz.

It is observed that, in all cases, the comparisons between the Fourier transform (5) and the reference spectrum are outside the defined thresholds, so it was determined that the Fourier transform (5) does not correspond to the reference spectrum (6).

### Example 4: Obtaining Other Reference Spectra

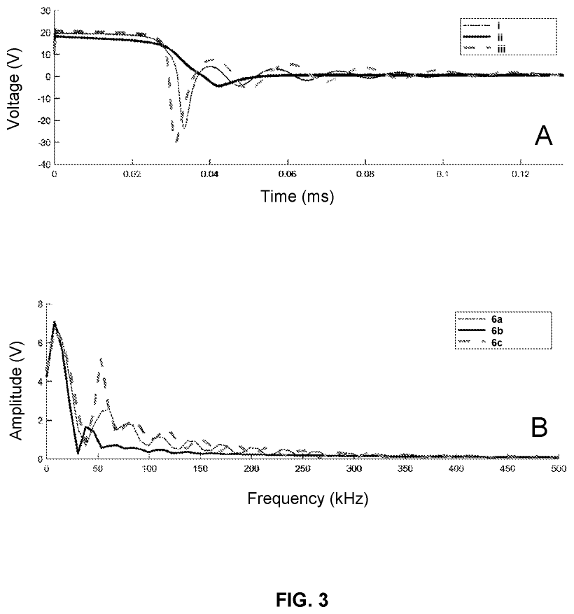

FIG. 3A illustrates a first reference signal (i) corresponding to a solar photovoltaic module (2) in normal operation; a second reference signal (ii) corresponding to a SPVM (2) with cracks; and a third reference signal (iii) corresponding to a SPVM (2) with soiling.

A fast Fourier transform of these reference signals was obtained, obtaining the reference spectra illustrated in FIG. 3B. A first reference spectrum (6a) was obtained from the first reference signal (i) and corresponds to a SPVM (2) in normal operation; a second reference spectrum (6b) was obtained from the second reference signal (ii) and corresponds to a SPVM (2) showing cracking; and a third reference spectrum (6c) was obtained from the third reference signal (iii) and corresponds to a SPVM (2) showing soiling.

### Example 5: Obtaining Parameters from Reference Spectra

The reference spectra of the previous example were used to obtain different parameters. Specifically, for each spectrum, the overshoot, undershoot, cutoff frequency, and damping coefficient parameters were obtained.

The results are summarized in Table 2:

TABLE 2
Parameters obtained from reference spectra

| | SPVM: | SPVM: | SPVM: |
|---|---|---|---|
| Parameter | NORMAL | CRACKS | SOILING |
| Overshoot (V) | 4.824 | 7.638 | 1.108 |
| Undershoot (V) | −23.98 | −4.746 | −30.11 |
| Cutoff Frequency (kHz) | 15.736 | 13.204 | 10.339 |
| Damping coefficient (ms) | 0.0300 | 0.0271 | 0.0346 |

1. A system for determining the operating state of a solar photovoltaic module, CHARACTERIZED in that it comprises:
means for acquiring a voltage signal, operatively connected to a voltage output of said solar photovoltaic module; and
a processor operatively connected to said means for acquiring said voltage signal output;
wherein said processor is configured to:
acquire, from said means for acquiring a voltage signal, an output voltage of said solar photovoltaic module;
obtain a Fourier transform of said voltage signal;
compare said Fourier transform with a reference spectrum; and
determine the operating state of said solar photovoltaic module from said comparison;
and wherein said acquisition of said output voltage signal is performed with said solar photovoltaic module in operation and connected to a power conversion system.

2. The system of claim 1, CHARACTERIZED in that said means for acquiring a voltage signal comprises a DC-DC converter including a switch, and in that said voltage signal is measured between the terminals of said switch.

3. The system of claim 1, CHARACTERIZED in that said reference spectrum is selected from the group consisting of spectra corresponding to soiling, spectra corresponding to cracks, spectra corresponding to hot spots, spectra corresponding to delamination, spectra corresponding to snail tracks, spectra corresponding to normal operation, as well as combinations thereof.

4. The system of claim 1, CHARACTERIZED in that said comparison comprises obtaining, from said Fourier transform and from said reference spectrum, a parameter which is selected from the group consisting of cutoff frequency and a damping coefficient, as well as a combination thereof; and in that said determination of the operating state comprises determining that said Fourier transform corresponds to said reference spectrum if the difference between the parameter obtained for the Fourier transform and for the reference spectrum is less than a threshold value.

5. The system of claim 4, CHARACTERIZED in that said threshold value is in the range between +/−0.1% and +/−1.0%.

6. The system of claim 1, CHARACTERIZED in that said comparison comprises obtaining a correlation coefficient between said Fourier transform and said reference spectrum; and in that said determination of the operating state comprises determining that said Fourier transform corresponds to said reference spectrum if said correlation coefficient is greater than a threshold value.

7. The system of claim 6, CHARACTERIZED in that said threshold value is in the range between 0.99 and 0.999.

8. The system of claim 1, CHARACTERIZED in that said comparison comprises obtaining a root mean square error between said Fourier transform and said reference spectrum; and in that said determination of the operating state comprises determining that said Fourier transform corresponds to said reference spectrum if said root mean square error is less than a threshold value.

9. The system of claim 8, CHARACTERIZED in that said threshold value is in the range between 0.005 Hz and 0.05 Hz.

10. A method for determining the operating state of a solar photovoltaic module, CHARACTERIZED in that it comprises:
acquiring, by means of means for acquiring a voltage signal operatively connected to a voltage output of said solar photovoltaic module, an output voltage signal of said solar photovoltaic module;
obtaining, by means of a processor operatively connected to said means for acquiring said output voltage signal, a Fourier transform of said voltage signal;
comparing, by means of said processor, said Fourier transform with a reference spectrum; and
determining, by means of said processor, the operating state of said solar photovoltaic module from said comparison;
and wherein said acquisition of said output voltage signal is performed with said solar photovoltaic module in operation and connected to a power conversion system.

11. The method of claim 10, CHARACTERIZED in that said reference spectrum is selected from the group consisting of spectra corresponding to soiling, spectra corresponding to cracks, spectra corresponding to hot spots, spectra corresponding to delamination, spectra corresponding to snail tracks, spectra corresponding to normal operation, as well as combinations thereof.

12. The method of claim 10, CHARACTERIZED in that said step of comparing said Fourier transform with said reference spectrum comprises obtaining, from said Fourier transform and from said reference spectrum, a parameter which is selected from the group consisting of cutoff frequency and a damping coefficient, as well as a combination thereof; and in that said step of determining the operating state of the solar photovoltaic module comprises determining that said Fourier transform corresponds to said reference spectrum if the difference between the parameter obtained for the Fourier transform and for the reference spectrum is less than a threshold value.

13. The method of claim 12, CHARACTERIZED in that said threshold value is in the range between +/−0.1% and +/−1.0%.

14. The method of claim 10, CHARACTERIZED in that said step of comparing said Fourier transform to said reference spectrum comprises obtaining a correlation coefficient between said Fourier transform and said reference spectrum; and in that said step of determining an operating state of said solar photovoltaic module comprises determining that said Fourier transform corresponds to said reference spectrum if said correlation coefficient is greater than a threshold value.

15. The method of claim 14, CHARACTERIZED in that said threshold value is in the range between 0.99 and 0.999.

16. The method of claim 10, CHARACTERIZED in that said step of comparing said Fourier transform to said reference spectrum comprises obtaining a root mean square error between said Fourier transform and said reference spectrum; and in that said step of determining the operating state of said solar photovoltaic module comprises determining that said Fourier transform corresponds to said reference spectrum if said root mean square error is less than a threshold value.

17. The method of claim 16, CHARACTERIZED in that said threshold value is in the range between 0.005 Hz and 0.05 Hz.
